(19) United States
(12) Patent Application Publication
(10) Pub. No.: US 2019/0208805 A1
(43) Pub. Date: Jul. 11, 2019

(54) PREPARATION OF SOLID CAPSULES COMPRISING FLAVOURS

(71) Applicant: Firmenich SA, Geneva 8 (CH)

(72) Inventors: Valery NORMAND, Plainsboro, NJ (US); Anandaraman SUBRAMANIAM, Hightstown, NJ (US); Jian ZHANG, Plainsboro, NJ (US)

(73) Assignee: Firmenich SA, Geneva 8 (CH)

(21) Appl. No.: 16/311,923

(22) PCT Filed: Jun. 30, 2017
(86) PCT No.: PCT/EP2017/066272

§ 371 Date: Dec. 20, 2018

Related U.S. Application Data
(60) Provisional application No. 62/357,366, filed on Jul. 1, 2016.

(51) Int. Cl. A23L 27/12; A23L 27/00

(52) U.S. Cl. CPC A23L 27/13; A23V 2002/00; A23L 27/80; A23L 27/72

(57) ABSTRACT

Provided herein is a process for preparing a solid particle comprising: preparing an emulsion comprising:
from 0.01 to 0.24%, by weight, of the final weight of the solid particle, of a saponin;
from 5 to 55%, by weight, of the total weight of the emulsion, a water soluble biopolymer having a molecular weight below 100 KDa;
from 5 to 60%, by weight, of the final weight of the solid particle, a flavor or fragrance comprising from about 50% to about 95% of limonene;
from about 5% to about 50%, by weight, of the final weight of the solid particle an alcohol; and
from about 15% up to about 80% of water;
the percentages being defined by weight;
   1. spray-drying the emulsion obtained in step 1) so as to obtain solid capsules;
   2. the solid capsule in which the droplet size measured by Diffusion Light Scattering is characterized by a characteristic diameter D₉₀ (90% of the population) equal or below 14 micrometers;
   3. and in which the alcohol is aliphatic saturated or unsaturated (from C₆ to C₁₂) pure or in mixture with log P ranging from 1.8 to 4.8 as calculated by the Suzuki method; or cyclic (i.e. phenol, vanillin . . . ); in the flavor or fragrance that will be used as a co-surfactant in conjunction with the natural extract comprising saponins when the concentration of the solid extract of saponin is equal or lower than 0.06% w/w to guaranty a droplet size below the limit according to 3) even under reduced quantity of surfactant.
e) An α value as calculated by the model that is between 2,500 and 10,250 cm²/g.

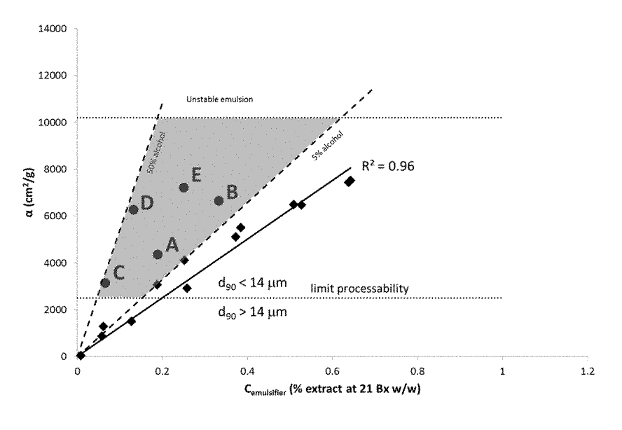

### TECHNICAL FIELD

The technical field herein related to processes for the preparation of solid capsules comprising flavors. Present invention relates to a process for the preparation of solid capsules comprising flavors, in which an emulsion comprising flavor or fragrance, a natural extract comprising saponins, short to medium chain alcohols, water and a water soluble film forming edible biopolymer having a molecular weight below 100 KDa is spray-dried. The invention further relates to the solid capsules as such and to products containing them.

### BACKGROUND

Spray-drying is a well-known technique for the encapsulation of flavors. Spray-dried products are commonly prepared from an emulsion that is sprayed into a drying chamber. The emulsion typically comprises flavors, a carrier and an emulsifier and sometimes a co-emulsifier. A number of emulsion parameters influence the quality of the spray-dried solid capsules. In particular, it is well-known to the person skilled in the art of spray-drying that it is desirable to spray dry a good emulsion, as defined by relatively small droplet size of the discontinuous phase, said emulsion also preferably remaining stable during the whole duration of the spray-drying process, taking into account that, depending on the manufacturing set-up, the time-delay between emulsion preparation and actual spray-drying can vary from a few minutes to several hours. The stability of the droplet size in the emulsion is even more important and difficult to achieve when high amounts of flavors are intended to be encapsulated.

It is therefore desirable to provide solid capsules obtained from emulsions having an enhanced stability and in particular having a droplet size which remains stable during a prolonged period of time.

The nature of the spray-drying process also requires the emulsions to be sprayable. The emulsion therefore cannot exceed a certain viscosity limit, which depends on the apparatus used. In order to decrease the viscosity, it is known to add water to the emulsion. However, the additional water will have to be evaporated during the drying step. Such evaporation has a high energy cost. It would therefore be desirable to provide means to further reduce the viscosity of the sprayed emulsion without further increasing the proportion of water.

Most of the time, biopolymers with surface active properties, such as for example gum Arabic, modified starches, modified cellulose, saponins, gelatin or even proteins such as albumin or beta-globulin, are used as emulsifiers.

It is desirable to develop a spray dry formulation that is stable and that ideally has no surface oil.

### SUMMARY

Provided herein is a process for preparing a solid particle comprising:

preparing an emulsion comprising
from 0.01 to 0.24%, by weight, of the final weight of the solid particle, of a saponin;
from 5 to 55%, by weight, of the total weight of the emulsion, a water soluble biopolymer having a molecular weight below 100 KDa;
from 5 to 60%, by weight, of the final weight of the solid particle, a flavor or fragrance comprising from about 50% to about 95% of limonene;
from about 5% to about 50%, by weight, of the final weight of the solid particle an alcohol; and
from about 15% up to about 80% of water;
the percentages being defined by weight;
1. spray-drying the emulsion obtained in step 1) so as to obtain solid capsules;
2. the solid capsule in which the droplet size measured by Diffusion Light Scattering is characterized by a characteristic diameter D₉₀ (90% of the population) equal or below 14 micrometers;
3. and in which the alcohol is aliphatic saturated or unsaturated (from C₆ to C₁₂) pure or in mixture with log P ranging from 1.8 to 4.8 as calculated by the Suzuki method; or cyclic (i.e. phenol, vanillin . . . ); in the flavor or fragrance that will be used as a co-surfactant in conjunction with the natural extract comprising saponins when the concentration of the solid extract of saponin is equal or lower than 0.06% w/w to guaranty a droplet size below the limit according to 3) even under reduced quantity of surfactant.
   e) An α value as calculated by the model that is between 2,500 and 10,250 cm²/g.

### DETAILED DESCRIPTION OF THE INVENTION

### Model Development:

The surface coverage of a surfactant is defined as the stable surface generated from a given quantity of surfactant with respect to the oil volume to be stabilized.

The total surface (S) of a number (N) of spherical oil drops with a known surface average diameter (d̅ₛ) is expressed as Eq. 1.

S=N(πd̅ₛ²) (1)

The number of oil drops (N) is also attainable through volume (V) relationship using the volume average diameter (d̅ᵥ) and Eq. 2.

$${V}_{oil} = N ( \frac{π}{6} {\overline{{d}_{v}}}^{3} ) \qquad ( 2 )$$

The total surface created (S) for a given volume of oil is given using Eq. 3.

$$\frac{S}{{V}_{oil}} = \frac{6 {\overline{{d}_{s}}}^{2}}{{\overline{{d}_{v}}}^{3}} \qquad ( 3 )$$

The volume of oil (Vₒᵢₗ) is also expressed as a function of the total volume (Vₜₒₜ) using the volume fraction of oil (ϕₒᵢₗ) in Eq. 4.

Vₒᵢₗ=ϕₒᵢₗVₜₒₜ (4)

Combining Eq. 3 and Eq. 4 results in Eq. 5 as an expression of the volumetric surface of an emulsion.

$$\frac{S}{{V}_{tot}} = \frac{6 {\overline{{d}_{s}}}^{2}}{{\overline{{d}_{v}}}^{3}} {φ}_{oil} \qquad ( 5 )$$

The total volume of the emulsion (Vₜₒₜ) can be expressed as Eq. 6 using total mass of the emulsion (mₜₒₜ) and the volumetric mass of the emulsion (μₜₒₜ) Assuming no interaction between the oil and the matrix, the volumetric mass of the sample (mₜₒₜ) is the sum of the volumetric masses of the individual constituents (μᵢ) affected by their volume fraction (ϕᵢ).

Vₜₒₜ=mₜₒₜ/μₜₒₜ (6)

The gravimetric surface of the emulsion (cc) can be expressed as Eq. 7 by substituting Vₜₒₜ in Eq. 5 with Eq. 6.

$$α = \frac{S}{{m}_{tot}} = \frac{6 {\overline{{d}_{s}}}^{2}}{{\overline{{d}_{v}}}^{3}} \frac{{φ}_{oil}}{{μ}_{tot}} \qquad ( 7 )$$

The surface (S) created has to be related to the number of surfactant molecules. If the emulsion is stable, then, the surface of the emulsion corresponds to a molecular fraction of the oil. If the surfactant is playing its role and assuming all surfactant molecules adsorb to the interface, the total surface created should be a function of the molecular head surface (sₕₛ) times the number of surfactant molecules in the system as written in Eq. 8.

$$S = \frac{{m}_{surf} {N}_{A} {s}_{hs}}{{M}_{surf}} \qquad ( 8 )$$

In Eq. 8, the m_{surf} is the mass of the surfactant (in gram), the N_{A} is the Avogadro constant (6.022×10²³ molecules·mol⁻¹), and M_{surf} is M the molecular weight of the surfactant (gram·mol⁻¹). The mass of the surfactant (m_{surf}) is the concentration in weight of the surfactant (C_{surf}) times the total mass of the emulsion (mₜₒₜ). Therefore, Eq. 8 can be rewritten as Eq. 9.

$$\frac{S}{{m}_{tot}} = ( \frac{{N}_{A} {s}_{hs}}{{M}_{surf}} ) {C}_{surf} \qquad ( 9 )$$

The final equation is:

$$α = \frac{S}{{m}_{tot}} = \frac{6 {\overline{{d}_{s}}}^{2}}{{\overline{{d}_{v}}}^{3}} \frac{{φ}_{oil}}{{μ}_{tot}} = ( \frac{{N}_{A} {s}_{hs}}{{M}_{surf}} ) {C}_{surf} = β {C}_{surf} \qquad ( 10 )$$

The representation of cc, the left expression of Eq. 10, as a function of the weight percentage of surfactant (C_{surf}) should show a linear relationship passing through zero (no surfactant=no stable emulsion) with a slope (β) as an intrinsic property of a surfactant in the emulsion system. Higher emulsification efficiency is expected for a surfactant with high value of the slope in an emulsion system.

### Process:

The process of the present invention comprises the step of preparing an emulsion comprising
a. from 0.01 to 0.24%, of the final weight of the solid particle, of a saponin;
b. from 5 to 55%, of the liquid emulsion, of a water soluble biopolymer having a molecular weight below 100 KDa;
c. from 5 to 60%, of the final weight of the solid particle, of flavour or fragrance containing 50 to 95% of limonene and from 5 to 50% of an alcohol; and
d. from 15 to 80% of water;
   the percentages being defined by weight.
   The prepared emulsion has a α value that is lower than 10,250 and higher than 2,500 cm²/g. The α value being calculated using the model disclosed in the present invention with d̅ₛ=d_{3,2} and d̅ᵥ=d_{4,3} when the droplet size distribution is bi-modal and d̅ₛ=d_{2,0} and d̅ᵥ=d_{3,0} when the droplet size distribution is mono-modal.

Saponins are amphiphilic glycosides composed of one or more hydrophilic glucoside moiety combined with a lipophilic triterpene derivative. Saponins are present in diverse plant extracts. As “natural extract comprising saponins”, it is meant here any saponin or mixture of substances comprising saponins obtained by applying a physical separation process to a raw material that is available in nature. Preferred natural extracts are those comprising at least 80% by weight, more preferably at least 50% by weight, even more preferably at least 20% by weight, most preferably at least 21% by weight, relative to the total weight of the extract, of saponins.

As preferred examples of natural extracts that can be used in the present invention, one can cite plant extracts, such as quillaja extract, camellia seeds extract, achyranthe extract, glycyrrhizine and stevia. Quillaja extract, which is obtained from the bark of Quillaja saponaria is particularly appreciated for the purpose of the present invention. Such plant extracts are commercially available from diverse suppliers. For example, quillaja extract can be purchased in a dilute form from Ingredion Incorporated under the trade name Q-Naturale™ (Quillaja extract in water).

In a preferred aspect of the invention, the extract is used in an amount of from 0.05 to 0.95% by weight, more preferably from 0.1 to 0.5% by weight, relative to the total weight of the dried capsule, even more preferably 0.285% by weight, relative to the total weight of the dried capsule.

Any water soluble biopolymer with a molecular weight below 100 kDa can be used for the purpose of the invention. By “water soluble biopolymer” is intended for the purpose of the present invention, any biopolymer which forms a clear solution in water, i.e. which forms a one-phase solution in water. Preferably, it forms a one phase solution when dissolved at 10%, more preferably even at 20% in water, and even more preferably up to 55% in water.

Preferred water soluble biopolymers are starch hydrolysates with a dextrose equivalent above 2. Examples of such biopolymers are disaccharides, oligosaccharides, polysaccharides.

Mostly preferred polysaccharides are selected from dextrins, maltodextrins, corn-syrups and inulins of various sources.

It is also particularly advantageous to use water soluble biopolymers which do not comprise any chemical substitution, meaning that the water soluble biopolymer has not been chemically (i.e. artificially) modified. Preferably, the water soluble biopolymer is available as such in nature and more preferably it is isolated from a natural source.

The water soluble biopolymer is preferably used in an amount of from 5 to 55% by weight, more preferably from 20 to 45% by weight, relative to the total weight of the emulsion.

For the purpose of the present invention, flavoring and/or perfuming ingredients encompass flavor and fragrance ingredients or compositions of current use in the flavor and/or fragrance industry, of both natural and synthetic origin. It includes single compounds and mixtures. Specific examples of such flavor and/or fragrance ingredients may be found in the current literature, e.g. in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander, 1969, Montclair, New Jerssey (USA). Many other examples of current flavoring and/or perfuming ingredients may be found in the patent and general literature available. The flavoring and/or perfuming ingredients may be present in the form of a mixture with solvents, adjuvants, additives and/or other components, generally those of current use in the flavor and fragrance industry.

“Flavoring ingredients” are well known to a person skilled in the art of aromatizing as being capable of imparting a flavor or taste to a consumer product, or of modifying the taste and/or flavor of said consumer product, or yet its texture or mouthfeel.

By “perfuming ingredients” it is understood here compounds which are used as active ingredients in perfuming preparations or compositions in order to impart a hedonic effect when applied on a surface. In other words, such compounds, to be considered as being perfuming ones, must be recognized by a person skilled in the art of perfumery as being able to impart or modify in a positive or pleasant way the odor of a composition or of an article or surface, and not just as having an odor. Moreover, this definition is also meant to include compounds that do not necessarily have an odor but are capable of modulating the odor of a perfuming composition, perfumed article or surface and, as a result, of modifying the perception by a user of the odor of such a composition, article or surface. It also contains malodor counteracting ingredients and compositions. By the term “malodor counteracting ingredient” we mean here compounds which are capable of reducing the perception of malodor, i.e. of an odor that is unpleasant of offensive to the human nose by counteracting and/or masking malodors. In a particular embodiment, these compounds have the ability to react with key compounds causing known malodors. The reaction result in reduction of the malodor materials' airborne levels and consequent reduction in the perception of the malodor.

“Alcohol” means a surface active alcohol in which the alcohol is a primary or secondary C₆-C₁₂ aliphatic (saturated or unsaturated) or cyclic (unsaturated or saturated) particularly with a log P ranging from 1.8 to 4.8 as calculated by the Suzuki method. Particular examples include but are not limited to food grade alcohols such as hexanol, heptanol, octanol, nonanol, decanol, phenylpropyl alcohol, cuminic alcohol, perycorolle, nerol, geraniol, phenylhexanol, lilyflore, citronellol, nonenol, mayol, rosalva, dimethyloctanol, carvacrol, thymol, carbinol, borneol, fenchyl alcohol, menthol, cyclopentol, undecavertol.

The flavor and/or fragrance is preferably used in an amount of from 5 to 30% by weight, more preferably from 10 to 20% by weight, relative to the total weight of the emulsion.

The emulsion may also contain optional ingredients. It may in particular further contain an effective amount of a fireproofing or explosion suppression agents. The type and concentration of such agents in spray-drying emulsions is known to the person skilled in the art. One can cite as non-limiting examples of such fireproofing or explosion suppression agents inorganic salts, C₁-C₁₂ carboxylic acids, salts of C₁-C₁₂ carboxylic acids and mixtures thereof. Preferred explosion suppression agents are, salicylic acid, citric acid, acetic acid, propionic acid, butyric acid, isobutyric acid, valeric acid, caproic acid, succinic acid, hydroxysuccinic acid, maleic acid, ascorbic acid, the potassium, calcium and/or sodium salts of any of the afore-mentioned acids, and mixtures of any of these. Other optional ingredients include antioxidants, colorants and dyes.

The emulsion can be formed using any known emulsifying method, such as high shear mixing, sonication or homogenization. Such emulsifying methods are well known to the person skilled in the art.

The characteristic droplet size d₉₀ of the emulsion is preferably not exceeding 14 microns. The characteristic droplet size remains below 14 microns for at least one day storage at ambient temperature (25° C.).

The viscosity of the emulsion is preferably comprised between 20 and 300 mPa·s, more preferably between 70 and 200 mPa·s and even more preferably between 100 and 150 mPa·s at the temperature at which the atomization step, as defined below, is carried out.

In step b), the emulsion is spray-dried so as to obtain solid capsules. The spray-drying process comprises two steps, the first one being dispersion and the second one being drying.

The emulsion is first subjected to an atomization step, during which the emulsion is dispersed in the form of drops into a spraying tower. Any device capable of dispersing the emulsion in the form of drops can be used to carry out such dispersion. For instance, the solution can be guided through a spraying nozzle or through a centrifugal wheel disk into the spraying tower. Vibrated orifices may also be used.

The size of the capsules is determined by the size and the water content of the drops that are dispersed into the tower. If a spraying nozzle is used for dispersing the drops, the size may be controlled by the flow rate of an atomizing gas though the nozzle, for example. In the case where a centrifugal wheel disk is used for dispersal, the main factor for adjusting droplet size in the centrifugal force with which the drops are dispersed from the disk into the tower. The centrifugal force, in turn, depends on the speed of rotation and the diameter of the disk. The feed flow rate of the emulsion, its surface tension and its viscosity are also parameters controlling the final drop size and size distribution. By adjusting these parameters, the skilled person in the art can control the size of the drops of the emulsion to be dispersed in the tower. Once sprayed in the chamber, the droplets are dried using any technique known in the art. These methods are perfectly documented in the patent and non-patent literature in the art of spray-drying. For example, Spray-Drying Handbook, 3^{rd} ed., K. Masters; John Wiley (1979), describes a wide variety of spray-drying methods.

The process of the present invention may be performed in any conventional spraying tower. A conventional multi-stage drying apparatus is for example appropriate for conducting the steps of this process. It may comprise a spraying tower, and, at the bottom of the tower, a fluidized bed intercepting partially dried particles after falling through the tower.

The solid capsules obtainable and/or obtained by the process described above are also an object of the present invention.

The obtained solid capsules typically comprise:
from 0.01 to 0.24% w/w of a saponin. [0.05 to 0.95% of an extract at 21% or 21 Brix (Bx)];
from 15 to 94% of a water soluble biopolymer having a molecular weight below 100 KDa;
from 0.5 to 10% of water; and
from 5 to 60% of flavor or fragrance;
   from which 5% to 50% is a primary, secondary or tertiary alcohol;
      the percentages being defined by weight, relative to the total weight of the capsules.

All components of the capsules are as defined above.

Preferably the solid capsules comprise between 0.5 and 5% by weight, preferably between 0.5 and 3% by weight of water, relative to the total weight of the solid capsules.

In a preferred aspect of the invention the size of the particles is typically comprised between 20 and 200 microns, more preferably between 50 and 100 microns, even more preferably from 75 to 85 microns.

The capsules of the invention have satisfying storage stability, even at 60% relative humidity.

In another aspect, the invention relates to a food product comprising the solid capsules of the invention. The food product of the invention preferably is a particulate or powdery food. In such a case, the capsules of the invention may easily be added thereto by dry-mixing.

In a preferred aspect of the invention, the food product is selected from the group consisting of an instant soup or sauce, a breakfast cereal, powdered milk, a baby food, a powdered drink, a powdered chocolate drink, a spread, a powdered cereal drink, a chewing gum, an effervescent tablet, a cereal bar, and a chocolate bar. The powdered foods or drinks may be intended to be consumed after reconstitution of the product with water, milk and/or a juice, or another aqueous liquid.

### EXAMPLES

The invention will now be described in further detail by way of the following examples.

### Example 1

### Preparation of Solid Capsules According to the Invention

Emulsion A was prepared by homogenizing the following ingredients:

TABLE 1
Composition of emulsion A

| Ingredient | Part (%) |
|---|---|
| Natural extract comprising saponins¹⁾ | 0.49 |
| Polysaccharide²⁾ | 38.30 |
| Flavor³⁾ | 14.83 |
| Alcohol⁴⁾ (Flavor:Alcohol = 90:10) | 1.65 |
| Water | 44.74 |

¹⁾Q-Naturale ™ (Solution of quillaja extract in water (21 Brix), origin: Ingredion Inc, NJ, USA)
²⁾Mixture 50:50 of 10DE maltodextrin and sucrose
³⁾Limonene as to mimic an orange flavor
⁴⁾Linalool as an alcohol used as part of perfumes or flavors

Polysaccharides (maltodextrin 10DE and sucrose) were incorporated in water. Q-Naturale™ was introduced as a liquid solution (21% w/w dry). Orange oil was added and the solution was stirred using a Lightnin® mixer (Lightnin, Rochester, N.Y.). Emulsion A was maintained at relatively high temperature i.e. 60° C. as example.

The emulsion was bimodal and its characteristic droplet size d₉₀ was 7.1 microns and cc parameter was 4,343 cm²/g.

Capsules A were prepared by spray-drying Emulsion A using a horizontal box dryer (Ernest D. Menold Inc., Lester, Pa.) equipped with high pressure homogenization and high pressure nozzle atomization. The feed was homogenized at 70 bars and atomization pressure was maintained at 70 bars. Inlet and outlet temperatures of the dryer were maintained at 170° C. and 72° C. respectively.

The obtained capsules had the composition of Table 2:

TABLE 2
composition of capsules A

| Ingredient | Part (%) |
|---|---|
| Solid saponins¹⁾ | 0.04 |
| Polysaccharide²⁾ | 69.61 |
| Flavor³⁾ | 25.66 |
| Alcohol⁴⁾ | 2.85 |
| Water | 1.84 |

¹⁾Dry Quillaja extract
²⁾Mixture 50:50 of 10DE maltodextrin and sucrose
³⁾Limonene as to mimic an orange flavor
⁴⁾Linalool as an alcohol used as part of perfumes or flavors

The obtained capsules were characterized by a glass transition temperature of 74° C. and the mean particle size was 46 microns whereas the d₉₀ of the powder was 157 microns.

### Example 2

### Preparation of Solid Capsules According to the Invention

Emulsion B was prepared by homogenizing the following ingredients:

TABLE 3
Composition of emulsion B

| Ingredient | Part (%) |
|---|---|
| Natural extract comprising saponins¹⁾ | 0.86 |
| Polysaccharide²⁾ | 38.27 |
| Flavor³⁾ | 13.17 |
| Alcohol⁴⁾ (Flavor:Alcohol = 80:20) | 3.29 |
| Water | 44.41 |

¹⁾Q-Naturale ™ (Solution of quillaja extract in water (21 Brix), origin: Ingredion Inc, NJ, USA)
²⁾Mixture 50:50 of 10DE maltodextrin and sucrose
³⁾Limonene as to mimic an orange flavor
⁴⁾Linalool as an alcohol used as part of perfumes or flavors

Polysaccharides (maltodextrin 10DE and sucrose) were incorporated in water. Q-Naturale™ was introduced as a liquid solution (21% w/w dry). Orange oil was added and the solution was stirred using a Lightnin® mixer (Lightnin, Rochester, N.Y.). Emulsion B was maintained at relatively high temperature i.e. 60° C. as example.

The emulsion was bimodal and its characteristic droplet size d₉₀ was 5.4 microns and cc parameter was 6,630 cm²/g.

Capsules B were prepared by spray-drying Emulsion B using a horizontal box dryer (Ernest D. Menold Inc., Lester, Pa.) equipped with high pressure homogenization and high pressure nozzle atomization. The feed was homogenized at 70 bars and atomization pressure was maintained at 70 bars. Inlet and outlet temperatures of the dryer were maintained at 170° C. and 72° C. respectively.

The obtained capsules had the composition of Table 4:

TABLE 4
Composition of capsules B

| Ingredient | Part (%) |
|---|---|
| Solid saponins¹⁾ | 0.07 |
| Polysaccharide²⁾ | 69.33 |
| Flavor³⁾ | 22.98 |
| Alcohol⁴⁾ | 5.75 |
| Water | 1.87 |

¹⁾Dry Quillaja extract
²⁾Mixture 50:50 of 10DE maltodextrin and sucrose
³⁾Limonene as to mimic an orange flavor
⁴⁾Linalool as an alcohol used as part of perfumes or flavors

The obtained capsules were characterized by a glass transition temperature of 74° C. and the mean particle size was 99 microns whereas the d₉₀ of the powder was 179 microns.

### Example 3

Preparation of Solid Capsules According to the Invention

Emulsion C was prepared by homogenizing the following ingredients:

TABLE 5
Composition of emulsion C

| Ingredient | Part (%) |
|---|---|
| Natural extract comprising saponins¹⁾ | 0.34 |
| Polysaccharide²⁾ | 38.31 |
| Flavor³⁾ | 9.89 |
| Alcohol⁴⁾ (Flavor:Alcohol = 60:40) | 6.59 |
| Water | 44.87 |

⁵⁾Q-Naturale ™ (Solution of quillaja extract in water (21 Brix), origin: Ingredion Inc, NJ, USA)
⁶⁾Mixture 50:50 of 10DE maltodextrin and sucrose
⁷⁾Limonene as to mimic an orange flavor
⁸⁾Linalool as an alcohol used as part of perfumes or flavors

Polysaccharides (maltodextrin 10DE and sucrose) were incorporated in water. Q-Naturale™ was introduced as a liquid solution (21% w/w dry). Orange oil was added and the solution was stirred using a Lightnin® mixer (Lightnin, Rochester, N.Y.). Emulsion C was maintained at relatively high temperature i.e. 60° C. as example.

The emulsion was bimodal and its characteristic droplet size d₉₀ was 7.9 microns and cc parameter was 6,250 cm²/g.

Capsules C were prepared by spray-drying Emulsion C using a horizontal box dryer (Ernest D. Menold Inc., Lester, Pa.) equipped with high pressure homogenization and high pressure nozzle atomization. The feed was homogenized at 70 bars and atomization pressure was maintained at 70 bars. Inlet and outlet temperatures of the dryer were maintained at 170° C. and 72° C. respectively.

The obtained capsules had the composition of Table 6:

TABLE 6
Composition of capsules C

| Ingredient | Part (%) |
|---|---|
| Solid saponins¹⁾ | 0.03 |
| Polysaccharide²⁾ | 70.43 |
| Flavor³⁾ | 16.58 |
| Alcohol⁴⁾ | 11.06 |
| Water | 1.90 |

⁵⁾Dry Quillaja extract
⁶⁾Mixture 50:50 of 10DE maltodextrin and sucrose
⁷⁾Limonene as to mimic an orange flavor
⁸⁾Linalool as an alcohol used as part of perfumes or flavors

The obtained capsules were characterized by a glass transition temperature of 73° C. and the mean particle size was 91 microns whereas the d₉₀ of the powder was 178 microns.

### Example 4

Preparation of Solid Capsules According to the Invention

Emulsion D was prepared by homogenizing the following ingredients:

TABLE 7
Composition of emulsion D

| Ingredient | Part (%) |
|---|---|
| Natural extract comprising saponins¹⁾ | 0.19 |
| Polysaccharide²⁾ | 38.32 |
| Flavor³⁾ | 9.89 |
| Alcohol⁴⁾ (Flavor:Alcohol = 60:40) | 6.60 |
| Water | 45.00 |

⁹⁾Q-Naturale ™ (Solution of quillaja extract in water (21 Brix), origin: Ingredion Inc, NJ, USA)
¹⁰⁾Mixture 50:50 of 10DE maltodextrin and sucrose
¹¹⁾Limonene as to mimic an orange flavor
¹²⁾Linalool as an alcohol used as part of perfumes or flavors

Polysaccharides (maltodextrin 10DE and sucrose) were incorporated in water. Q-Naturale™ was introduced as a liquid solution (21% w/w dry). Orange oil was added and the solution was stirred using a Lightnin® mixer (Lightnin, Rochester, N.Y.). Emulsion D was maintained at relatively high temperature i.e. 60° C. as example.

The emulsion was bimodal and its characteristic droplet size d₉₀ was 6.1 microns and cc parameter was 3,122 cm²/g.

Capsules D were prepared by spray-drying Emulsion D using a horizontal box dryer (Ernest D. Menold Inc., Lester, Pa.) equipped with high pressure homogenization and high pressure nozzle atomization. The feed was homogenized at 70 bars and atomization pressure was maintained at 70 bars. Inlet and outlet temperatures of the dryer were maintained at 170° C. and 72° C. respectively.

The obtained capsules had the composition of Table 8:

TABLE 8
Composition of capsules D

| Ingredient | Part (%) |
|---|---|
| Solid saponins¹⁾ | 0.02 |
| Polysaccharide²⁾ | 70.16 |
| Flavor³⁾ | 16.21 |
| Alcohol⁴⁾ | 10.81 |
| Water | 2.80 |

⁹⁾Dry Quillaja extract
¹⁰⁾Mixture 50:50 of 10DE maltodextrin and sucrose
¹¹⁾Limonene as to mimic an orange flavor
¹²⁾Linalool as an alcohol used as part of perfumes or flavors

The obtained capsules were characterized by a glass transition temperature of 65° C. and the mean particle size was 46 microns whereas the d₉₀ of the powder was 157 microns.

### Example 5

Preparation of Solid Capsules According to the Invention

Emulsion E was prepared by homogenizing the following ingredients:

TABLE 9
Composition of emulsion E

| Ingredient | Part (%) |
|---|---|
| Natural extract comprising saponins¹⁾ | 0.64 |
| Polysaccharide²⁾ | 38.28 |
| Flavor³⁾ | 11.53 |
| Alcohol⁴⁾ (Flavor:Alcohol = 70:30) | 4.94 |
| Water | 44.61 |

¹³⁾Q-Naturale ™ (Solution of quillaja extract in water (21 Brix), origin: Ingredion Inc, NJ, USA)
¹⁴⁾Mixture 50:50 of 10DE maltodextrin and sucrose
¹⁵⁾Limonene as to mimic an orange flavor
¹⁶⁾Linalool as an alcohol used as part of perfumes or flavors

Polysaccharides (maltodextrin 10DE and sucrose) were incorporated in water. Q-Naturale™ was introduced as a liquid solution (21% w/w dry). Orange oil was added and the solution was stirred using a Lightnin® mixer (Lightnin, Rochester, N.Y.). Emulsion E was maintained at relatively high temperature i.e. 60° C. as example.

The emulsion was bimodal and its characteristic droplet size d₉₀ was 5.1 microns and cc parameter was 7,200 cm²/g.

Capsules E were prepared by spray-drying Emulsion E using a horizontal box dryer (Ernest D. Menold Inc., Lester, Pa.) equipped with high pressure homogenization and high pressure nozzle atomization. The feed was homogenized at 70 bars and atomization pressure was maintained at 70 bars. Inlet and outlet temperatures of the dryer were maintained at 170° C. and 72° C. respectively.

The obtained capsules had the composition of Table 8:

TABLE 10
Composition of capsules E

| Ingredient | Part (%) |
|---|---|
| Solid saponins¹⁾ | 0.05 |
| Polysaccharide²⁾ | 69.27 |
| Flavor³⁾ | 19.82 |
| Alcohol⁴⁾ | 8.50 |
| Water | 2.37 |

¹³⁾Dry Quillaja extract
¹⁴⁾Mixture 50:50 of 10DE maltodextrin and sucrose
¹⁵⁾Limonene as to mimic an orange flavor
¹⁶⁾Linalool as an alcohol used as part of perfumes or flavors

The obtained capsules were characterized by a glass transition temperature of 69° C. and the mean particle size was 38.5 microns whereas the d₉₀ of the powder was 98 microns.

1. A process for preparing citrus flavor or fragrance solid capsules, the process comprising the steps of:
a) preparing an emulsion comprising
from 0.01 to 0.24%, of the final weight of the solid particle, of a saponin;
from 5 to 55%, of the liquid emulsion, of a water soluble biopolymer having a molecular weight below 100 KDa;
from 5 to 60%, of the final weight of the solid particle, of flavor or fragrance containing 50 to 95% of limonene and from 5 to 50% of an alcohol; and
from 15 to 80% of water;
the percentages being defined by weight;
b) spray-drying the emulsion obtained in step a) so as to obtain solid capsules;
c) the solid capsule in which the droplet size measured by Diffusion Light Scattering is characterized by a characteristic diameter D₉₀ (90% of the population) equal or below 14 micrometers.
d) In which the alcohol is aliphatic saturated or unsaturated (from C6 to C12) pure or in mixture with log P ranging from 1.8 to 4.8 as calculated by the Suzuki method; or cyclic (i.e. phenol, vanillin . . . ); in the flavor or fragrance that will be used as a co-surfactant in conjunction with the natural extract comprising saponins when the concentration of the solid extract of saponin is equal or lower than 0.06% w/w to guaranty a droplet size below the limit according to 1.c) even under reduced quantity of surfactant.
e) An α value as calculated by the model that is between 2,500 and 10,250 cm²/g.

2. The process according to claim 1, wherein the saponin is provided in the process by the addition of a natural extract comprising 10% by weight of saponins, relative to the total weight of the extract.

3. The process according to claim 1, wherein the natural extract is a plant extract.

4. The process according to claim 3, wherein the natural extract is a quillaja extract.

5. The process according to claim, wherein the water soluble biopolymer is a starch hydrolysate with a dextrose equivalent above 2.

6. The process according to claim, wherein the water soluble biopolymer is selected from dextrins, maltodextrins and corn syrup.

7. The process according to claim, wherein the flavour or fragrance has a log P value of 2 or more.

8. The process according to claim, wherein the natural extract is used in an amount comprised between 0.2 and 5% by weight, relative to the total weight of the emulsion.

9. The process according to claim, wherein the water soluble polymer is used in an amount comprised between 10 and 50% by weight, relative to the total weight of the emulsion.

10. The process according to claim, wherein the flavor or fragrance is used in an amount comprised between 7 and 45% by weight, relative to the total weight of the emulsion.

11. Solid capsules obtainable by the process of claim 1.

12. The solid capsules according to claim 11, comprising:
from 0.7 to 30% of a natural extract comprising saponins
from 15 to 95% of a a water soluble biopolymer having a molecular weight below 100 KDa,
from 5 to 75% of flavor;
from 0.25 to 37.5% of alcohol; and
from 0.5 to 10% of water;
the percentages being defined by weight, relative to the total weight of the capsules.

13. The food product comprising the solid capsules according to claim 11.

14. The food product according to claim 13, in the form of a particulate or powdery food.

15. The food product according to claim 13, in the form of an instant soup or sauce, a breakfast cereal, a powdered milk, a baby food, a powdered drink, a powdered chocolate drink, a spread, a powdered cereal drink, a chewing gum, an effervescent tablet, a cereal bar, and a chocolate bar.
